(19) United States
(12) Patent Application Publication
(10) Pub. No.: US 2025/0262616 A1
(43) Pub. Date: Aug. 21, 2025

(54) LOW PRESSURE PLASMA MODIFIED PLASTIC HEMATOCRIT TUBE

(71) Applicant: ACCU-GLASS LLC, St. Louis, MO (US)

(72) Inventors: Benjamin Henry LASSANSKE, St. Louis, MO (US); William NEUBERT, St. Louis, MO (US); Thomas PESCH, St. Louis, MO (US); Craig STOUT, Port Matilda, PA (US)

(21) Appl. No.: 18/442,577

(22) Filed: Feb. 15, 2024

(51) Int. Cl. B01L 3/00

(52) U.S. Cl. CPC B01L 3/502; B01L 2300/042; B01L 2300/12; B01L 2300/16; B01L 2400/0406

(57) ABSTRACT

A blood collection device including a plastic hematocrit tube having a first open end, a second open end opposite the first open end, and a sidewall which together define an elongated collection body, wherein an interior wall surface area of the elongated collection body is treated with a plasma generated from a gas containing oxygen, whereby the plasma-treated interior wall surface area is modified such that a capillary action for drawing blood is achieved by inducing a low-pressure environment to allow plasma ions to travel a length of the elongated collection body.

### FIELD OF DISCLOSURE

The present invention is directed to a plastic hematocrit tube, or more particularly, to a low-pressure plasma modified plastic hematocrit tube.

### BACKGROUND

Current blood plasma screening hematocrit tubes are most often made of either glass or plastic. The glass products have adequate capillary action and can be coated with anticoagulants. However, glass hematocrit tubes have a risk of breakage which creates a hazardous condition for the user. In most cases, the U.S. Center for Disease Control advises against the use of glass capillaries. In other approaches, plastic wrapped glass hematocrit tubes are available. However, plastic wrapped glass hematocrit tubes still do not prevent breakage. They only mitigate the potential for leakage of contents up to a certain bend angle of approximately 45 degrees.

On some occasions, integrating a plug into the tube is applied to allow centrifugation and dispensing of contents for further testing. However, an integrated plug requires that a flared end be present to retain the tube in a tube dispenser. This flare is known to break, causing contamination of the dispenser and a loss of the sample. In one approach, to eliminate risks associated with glass hematocrit tube breakage, plastic hematocrit tubes have been used. However, current dispensing pipettors using plastic tubes prohibit the dispensing of the sample. These tubes do not have pre-inserted plugs for centrifugation and dispensing. In addition, the plastic tubes can easily slip out of conventional tube dispensers designed to grip the flared end. Furthermore, adding a flare to the plastic is not desirable because the plastic material can easily deform under the load. Finally, commercially available plastic hematocrit tubes are not compatible with other dispensers in the market as these tubes typically lack a flared end.

While plastic hematocrit tubes are known and can eliminate the hazards associated with glass tube breakage, these tubes however cannot be employed with an integrated plug. An integrated plug is not practical for a plastic tube because current tube dispensers require a flared end outer diameter to hold the tube during dispensing. A flared end outer diameter in plastic would not have adequate holding strength as compared to traditional materials, such as glass. Instead, plastic tubes must use a clay or other pliable sealing material, which creates the potential for contamination. Further, plastic capillary tubes are also known to be hydrophobic, and thus do not exhibit the desired capillary action for drawing blood into the tube. In some occasions, application of an ion plasma onto the surface of plastics is known to increase the surface energy of the plastic, which makes the surface hydrophilic and therefore enables the desired capillary action. However, this treatment requires highly specialized manufacturing processes such as long linear electrodes that must be directed down the small central bore of the tube, which is time consuming and costly. Also, these tubes are still of limited use as a hematocrit tube because they do not have an integrated plug.

In view of above, there is a need in the art for a plastic hematocrit tube that do not suffer from the above shortcomings.

### SUMMARY

In an example embodiment, a blood collection device includes a plastic hematocrit tube having a first open end, a second open end opposite the first open end, and a sidewall which together define an elongated collection body, wherein an interior wall surface area of the elongated collection body is treated with a plasma generated from a gas containing oxygen, whereby the plasma-treated interior wall surface area is modified such that a capillary action for drawing blood is achieved by inducing a low-pressure environment to allow plasma ions to travel a length of the elongated collection body.

In another example embodiment, a blood collection assembly includes a plastic hematocrit tube having a first open end, a second open end opposite the first open end, and a sidewall which together define an elongated collection body, wherein an interior wall surface area of the elongated collection body is treated with a plasma generated from a gas containing oxygen, whereby the plasma-treated interior wall surface area is modified by applying low-pressure to allow plasma ions to travel a length of the elongated collection body, and wherein the interior wall surface area of the elongated collection body is treated with an anticoagulant to enhance capillary action, and a plug configured to be inserted in one of the first end open end or the second open end.

In yet another example embodiment, a method for modifying an interior surface of a blood collection device includes placing a plastic hematocrit tube within a plasma discharge apparatus, subjecting the plastic hematocrit tube with a plasma generated from a gas containing oxygen, providing a low-pressure environment within the plasma discharge apparatus, whereby the low-pressure environment allows plasma ions to travel a length of an inner surface of the plastic hematocrit tube to form a modified inner surface, and treating the modified inner surface with an anticoagulant for enhanced capillary action.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a perspective view of an exemplary a tube and a sealing plug, according to an example embodiment of the present disclosure.

FIG. 2 is a flowchart of a method of modifying an interior surface of a tube, according to an example embodiment of the present disclosure.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of layers, regions and/or structural elements may be reduced or exaggerated for clarity. Wherever possible, the same reference numbers will be used throughout the drawings to represent the same parts.

### DETAILED DESCRIPTION

As used herein, a “sample” may be but is not limited to a blood sample, or a portion of a blood sample, may be of any suitable size or volume, and is preferably of small size or volume. In some embodiments of the assays and methods disclosed herein, measurements may be made using a small volume blood sample, or no more than a small volume portion of a blood sample, where a small volume includes a volume between about 0.01 μL to a volume of about 50 mL.

As used herein, a “fluid” may be any fluid obtained or obtainable from a subject. A fluid may be, for example, blood, urine, saliva, tears, sweat, a bodily secretion, a bodily excretion, or any other fluid originating in or obtained from a subject. Exemplary bodily fluids include, without limitation, blood, serum, plasma, bone marrow, saliva, urine, gastric fluid, spinal fluid, tears, sweat, oil, glandular secretions, cerebral spinal fluid, semen, vaginal fluid, interstitial fluids derived from tumorous tissue, ocular fluids, placental fluid, amniotic fluid, cord blood, lymphatic fluids, cavity fluids, sputum, meconium, breast milk and/or other secretions or excretions.

As used herein, a “tube” may be a vessel to collect and hold a sample. In one implementation, the tube is a hematocrit tube used for collecting blood samples via capillary action and measuring the volume percentage of red blood cells in those samples. In some instances, the tube can be disposable. For example, the tube can be used once and disposed. Optionally, the tube can be reused any number of times. In some implementations, the tube can include both reusable and disposable components.

The present device provides an improved plastic hematocrit tube (with or without an integrated plug) that combines the benefits of glass and plastic hematocrit tubes, while eliminating the problems associated with only plastic tubes. As an example, the present device consists of a plastic hematocrit tube that is surface modified by low pressure reactive plasma and an anticoagulant coating. The material is pliable that it can be gripped or engaged by a dispensing pipettor (with or without an integrated plug).

To describe differently, the present device uses low-pressure plasma to allow surface modification on an inner diameter of the plastic tube without the need for insertion of an instrument, i.e., an electrode. That is, the low pressure (versus ambient atmospheric pressure) increases the mean free path length, allowing the plasma ions to travel the entire length of the plastic tube. As a result, this becomes a batch operation and eliminates the time-consuming process of individually inserting an electrode. Also, this plasma treatment makes the plastic relatively hydrophilic, which allows an aqueous solution of anticoagulant (e.g., ammonium heparin) to be applied. In addition, the use of the anticoagulant protects the plasma treated surface such that the capillary action is extended.

Another benefit of the present disclosure is the improved protection from biohazardous spillage. For instance, while conventional MYLAR® wrapped glass tube contains spills from breakage up to approximately 45 degrees bend angle, the present plastic tube contains materials to a much higher bend angle-greater than 90 degrees.

Furthermore, the present device can be intended to work with a pre-installed synthetic plug that can be dispensed while compressed into the pliable plastic material.

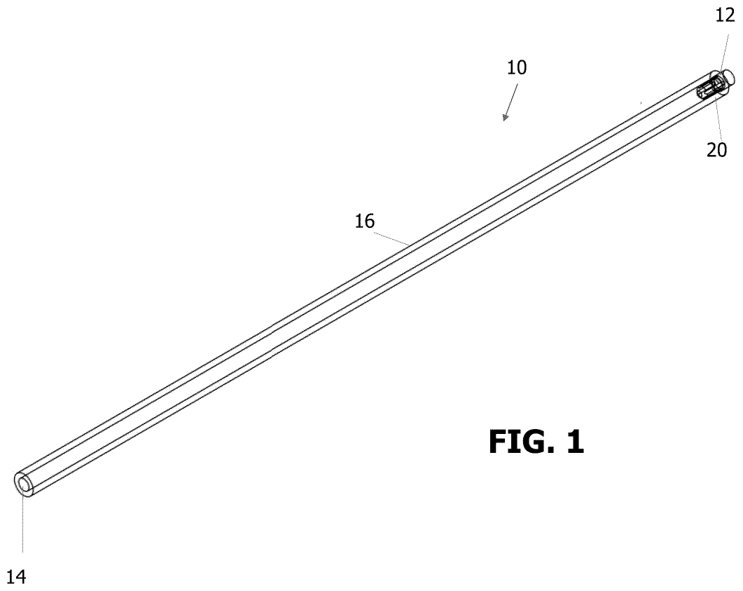

FIG. 1 illustrates an example embodiment of a plastic hematocrit tube 10 which will now be described herein. Tube 10 can be made from a plastic material. In general, suitable materials for tube 10 may be selected from various thermoplastics, including, without limitation, polyamides, polyurethanes, polyesters, functionalized polyolefins, polycarbonate, polysulfones, polyimides, polyketones, liquid crystal polymers and any combination thereof. Preferred suitable material for tube 10 includes, without limitation, MAKROLON 3108 polycarbonate resin.

Tube 10 has a first open end 12, a second open end 14 opposite the first open end 12, and a sidewall 16 which together define an elongated collection body. An exemplary tube 10 can have a length of approximately 3 in, an inner diameter of approximately 0.044 in, an outer diameter of approximately 0.080 in, and a volume of approximately 75 μL. It should be understood that other sizes and volumes can be employed depending on the specific use of sampling of the fluid.

In some implementations, tube 10 can have a flared end at the first open end 12. Typically, a conventional dispensing pipettor is designed to engage with the flared end to hold the tube 10 in its place during dispensing of the fluid sample. In other implementations, tube 10 is free of a flared end at one end. Accordingly, the present apparatus described herein is adaptable such that a flared end tube can be used with the dispensing pipettor as described in co-pending U.S. patent application Ser. No. ______ to Stout et al., entitled “Hematocrit Tube Dispenser,” incorporated herein by reference.

In some implementations, at the first open end 12 of tube 10, a sealing plug 20 is provided, which is adapted to be inserted in tube 10 to force the fluid out, i.e., second open end 14, of the tube 10. The sealing plug 20 is at least partially insertable in the first open end 12 and adapted to be slidably movable inside of the tube 10 caused by the movement of a plunger of the dispensing pipettor. An exemplary plug can be a self-scaling plug, such as, for example, a clay based self-sealant plug or other pliable sealing material. In other implementations, the plug can include at least one channel defining a passageway for extracting vapor contained in the tube as described in co-pending U.S. patent application Ser. No. 17/650,000 to Stout et al., entitled “Capillary Tube Closure,” incorporated herein by reference.

In some implementations, tube 10 can include an anticoagulant (e.g., ammonium heparin, sodium or others) that keeps the blood from clotting. In this instance, tube 10 can have a color-coded end to easily identify an anticoagulant treated tube from a plain tube, i.e., non-anticoagulant treated tube. In some implementations, tube 10 can be coated or wrapped with a material to contain the fluid sample in the event of breakage and/or protect against cuts from broken glass. For example, the wrapped material can be a polyester film, such as, MYLAR. Unlike conventional plastic wrapped glass tubes, which only mitigate against potential breakage of contents up to a bend angle of approximately 45 degrees, the present device contains materials to a much higher bend angle-greater than 90 degrees, for example. In other implementations, a protective layer such as a transparent or translucent layer overlies an outer surface of tube 10, permitting an operator or user to view the contents (e.g., liquid or fluid) therein. In other implementations, the tube 10 can be treated with a coating for enhanced capillary action. It should further be appreciated that other coatings, layers, surfaces, etc. can be applied for different purposes.

In accordance with example embodiments described herein, it has been found that treatment of the plastic tube 10 with a plasma in a low-pressure vacuum allowed surface modification on an inner diameter of the plastic tube 10 without the need for insertion of an electrode. More specifically, the low pressure increased the average gaseous molecule will travel before it encounters another gaseous molecule. In gaseous kinetics, this is referred to as “mean free path.” This allows the plasma ions to travel the entire length of the inner diameter of the plastic tube 10. As a result, this became a batch operation and eliminated the time-consuming process of individually inserting an electrode into tube 10. In addition, the plastic tube 10 became more hydrophilic, which allows an aqueous solution of anticoagulant (e.g., ammonium heparin) to be applied for capillary action. Unlike conventional processes, plasma ions do not readily travel down small tube diameters. Instead, the ions collide with other atoms or otherwise deionize prior to traveling the length of the tube. In order to resolve this issue, conventional processes used specialized electrodes that are inserted into the tube to generate the plasma. As such, this required the outer and inner diameters of the tube to be tightly controlled as datum surfaces.

In some implementations, the plasma may be generated from a suitable process gas, such as, for example, oxygen. Unlike conventional processes, where argon is often used as the plasma source, which is relatively slow and therefore, a costly process. While oxygen is the preferred process gas, it should be appreciated that other gases can be used, such as, but not limited to, nitrogen, ammonia, carbon dioxide, sulfur dioxide, air, or a combination thereof.

In some implementations, the present device is particularly suitable in connection with the treatment of a hematocrit tube having interior surfaces which are not easily contacted, such as mid-length interior surfaces of tubing having an especially small internal diameter and properties that can be improved by attaching an anticoagulant coating for capillary action.

For treatment of tube 10, attachment of plasma onto the surface of tube 10 includes positioning the tube 10 having the polymeric surface within an apparatus to provide a plasma discharge environment. Devices for providing such an environment are generally known in the art. For example, a reactor chamber is provided, and tube 10 having the surface to be treated is placed in the chamber without requiring any special structures or positioning. In some implementations, when interior surfaces are to be treated, the chamber is evacuated by a suitable vacuum pump or the like, typically to a pressure below the treatment pressure targeted for the plasma discharge. Specific pressures will be discussed in detail later. A source of process gas, for example, oxygen which provides the plasma environment then is fed into the chamber, and the desired treatment pressure for the plasma medium is developed and/or maintained. Other devices for generating plasma are generally known in the art, and not fully described herein.

In accordance with the present disclosure, when the process gas or plasma medium is provided within the chamber, reactive species are created. The reactive species, when they encounter the polymeric surface, react with atoms and/or molecules of the polymeric material, thereby modifying the chemical nature of the surface. It is known that polymeric surface is modified by causing the formation of carboxyl groups and/or hydroxyl groups on the surface of the polymeric material. The entire tube 10 including the interior surfaces will thus be treated, provided the low-pressure conditions are maintained.

With more particular reference to the desired treatment pressure, the present disclosure determined that lowering the pressure increased the mean free path. A longer mean free path at reduced pressures resulted in increased diffusion length of the reactive species. As known, the mean free path length is determined according to the relationship below:

$$ℓ = \frac{μ}{ρ} \sqrt{\frac{π m}{2 {k}_{B} T}} = \frac{μ}{p} \sqrt{\frac{π {k}_{B} T}{2 m}} ,$$

TABLE 1 below illustrates the mean free path length in relation to the reduced pressure.

TABLE 1

| | Pressure in | Pressure in | Number density | Number density | Mean free | |
|---|---|---|---|---|---|---|
| Vacuum range | hPa (mbar) | mmHg(Torr) | (Molecules/cm³) | (Molecules/m³) | path | |
| Ambient | 1013 | 759.8 | 2.7 × 10¹⁹ | 2.7 × 10²⁵ | 64-68 | nm |
| pressure | | | | | | |
| Low vacuum | 300-1 | 220-8 × 10⁻¹ | 10¹⁹-10¹⁶ | 10²⁵-10²² | 0.1-100 | μm |
| Medium | 1-10⁻³ | 8 × 10⁻¹-8 × 10⁻⁴ | 10¹⁶-10¹³ | 10²²-10¹⁹ | 0.1-100 | mm |
| vacuum | | | | | | |
| High vacuum | 10⁻³-10⁻⁷ | 8 × 10⁻⁴-8 × 10⁻⁸ | 10¹³-10⁹ | 10¹⁹-10¹⁵ | 10 cm-1 km | |
| Ultra-high | 10⁻⁷-10⁻¹² | 8 × 10⁻⁸-8 × 10⁻¹³ | 10⁹-10⁴ | 10¹⁵-10¹⁰ | 1 km-10⁵ km | |
| vacuum | | | | | | |
| Extremely | <10⁻¹² | <8 × 10⁻¹³ | <10⁴ | <10¹⁰ | >10⁵ | km |
| high vacuum | | | | | | |

As shown in TABLE 1, at ambient pressure of 1013 mbar (759.8 Torr), the mean free path only reached 64-68 nm, while at lower pressures, the mean free path lengths increased exponentially. For example, at low vacuum pressure of 300-1 mbar (220-8×10⁻¹ Torr), the mean free path reached 0.1-100 μm; at medium vacuum pressure of 1-10⁻³ mbar (8×10⁻¹-8×10⁻⁴ Torr), the mean free path reached 0.1-100 mm; at high vacuum pressure of 10⁻³-10⁻⁷ mbar (8×10⁻⁴-8×10⁻⁸ Torr), the mean free path reached 10 cm-1 km; at ultra-high vacuum pressure of 10⁻⁷-10⁻¹² mbar (8×10⁻⁸-8×10⁻¹³ Torr), the mean free path reached 1 km-10⁻⁵ km; and extremely high vacuum pressure of <10⁻¹² mbar (<8×10⁻¹³ Torr), the mean free path reached >10⁻⁵ km.

Accordingly, as pressures approaches 0.1 mbar, the mean free path is longer than the length of a typical hematocrit tube (i.e., 75 mm), thus allowing ions to travel the entire length of the inner diameter of the tube. Hence, the low-pressure oxygen plasma process lowers production costs for plastic hematocrit tubes, eliminating the need for special electrodes and/or gases (i.e., argon).

In some implementations, during plasma treatment, the tube is exposed to 30 W of electromagnetic power from the plasma generator. The duration of the plasma exposure is approximately 5 minutes. The temperature of the plasma may be from room temperature to many thousands of degrees Kelvin, due to the rarefied nature of the plasma.

The resulting modified polymeric surface is then treated with an anticoagulant agent for capillary action. A defined amount of solution, based on anticoagulant concentration, is applied to one end of the tube. The solution is drawn through the length of the tube. Once complete, the applied solution is drawn in the opposite direction over the entire length. Excess solution to expelled, via forced air, from the interior portion of the tube. Residual moisture is evaporated when exposed to 100 C air until moisture is completely removed. A suitable anticoagulant agent is ammonium heparin. The anticoagulant agent is applied in the form of an aqueous solution. The aqueous solution is comprised of 3000 USP units of ammonium heparin per mL of deionized water.

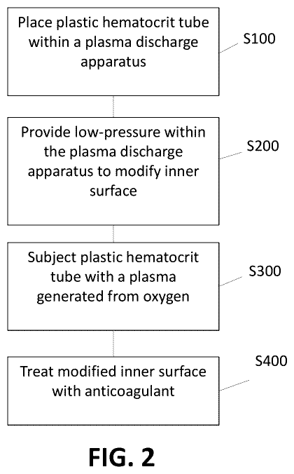

FIG. 2 is a flowchart of a method of modifying an interior surface of a blood collection device, according to an example embodiment. In step S100, the plastic hematocrit tube is placed within a plasma discharge apparatus. In an example, the plasma discharge apparatus is a reaction chamber. Then in step S200, a low-pressure is applied within the plasma discharge apparatus. In an example, the applied low-pressure is approximately 0.1 mbar or less. Then in step S300, the plastic hematocrit tube is subjected to a plasma generated from a process gas. Preferred gas is oxygen. This exposure to plasma in a low-pressure environment allows plasma ions to travel a length of an inner surface of the plastic hematocrit tube to form a modified inner surface. Then finally, in step S400, the modified inner surface is treated with an anticoagulant for enhanced capillary action.

In some implementations, as shown in FIG. 1, plug 20 is used with the present tube 10. The compressible plastic tube material can be gripped with a gripping mechanism that deforms the outer diameter of the tube in order to dispense the sample, as described in co-pending U.S. patent application Ser. No. ______ to Stout et al., entitled “Hematocrit Tube Dispenser,” incorporated herein by reference. As such, the present disclosure provides a benefit in the safety and efficiency of the hematocrit sampling process including a plastic tube and an integrated plug. This produces the sampling process to less likely result in a biohazardous leak, much less likely to result in a broken collection tube, and more likely to dispense effectively. Unlike conventional plastic products, these products cannot include an integrated plug; but instead used a hydrophilic sealing mechanism involving absorbent polymers. As such, the hydrophilic seal must be mechanically pushed out of a tube, and is not actionable with air pressure dispensing. Other conventional products, such as, a glass tube, used a flared end to hold the glass tube and push the sealing plug during dispensing. While a flared end is possible in glass, it is more difficult in a plastic tube without costly custom molds. As a result, there is no means of pushing a plug through a plastic tube with existing dispensers or pipettors.

In some implementations, the present device may be used in a variety of applications. This includes blood chemistry screening, disease and virus testing, and blood typing. In some implementations, other application is in the milk production industry where milk is collected into a hematocrit tube, centrifuged, and dispensed into an analyzer to test the fat quality and concentration, for example.

As described herein, the term “user,” as used herein, refers to a health care professional providing medical treatment and/or medical advice to a subject. A health care professional may include a person or entity that is associated with the health care system. Examples of health care professionals may include physicians (including general practitioners and specialists), surgeons, physician assistants, nurses, lab technicians, and a wide variety of trained personnel to provide some type of health care service. A health care professional may work in or be affiliated with hospitals, labs, and health care locations, or also in academic training, research and administration.

As described herein, in general expressions, the term “proximal” end relates to an end being closest to the user, and the term “distal” end relates to an end being farthest from the user. Alternatively, in relation to the tube, the term “proximal” end relates to an end where the sealing plug engages thereof, and the “distal” end relates to an end closest to the user.

As used herein, “dispenser” or “pipettor” or any other dispensing mechanism can be a laboratory tool commonly used in chemistry, biology, and medicine to transport and dispense a measured volume of fluid. For example, the dispenser and/or any other portion thereof may be capable of receiving a tube containing a single type of sample, or multiple types of samples. For example, the dispenser may be capable of receiving a tube containing blood.

The articles “a” and “an,” as used herein, mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

“At least one,” as used herein, means one or more and thus includes individual components as well as mixtures/combinations.

The transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinarily associated with the specified material(s). The term “consisting essentially of” limits the scope of a claim to the specified elements, steps or material(s) and those that do not materially affect the basic and novel characteristic(s) of the claimed disclosure. All materials and methods described herein that embody the present disclosure can, in alternate embodiments, be more specifically defined by any of the transitional terms “comprising,” “consisting essentially of,” and “consisting of.”

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Spatially relative terms (e.g., “beneath,” “below,” “lower,” “above,” “upper” and the like) may be used herein for case of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A blood collection device, comprising:
a plastic tube having a first open end, a second open end opposite the first open end, and a sidewall which together define an elongated collection body,
wherein an interior wall surface area of the elongated collection body is treated with a plasma generated from a gas containing oxygen, whereby the plasma-treated interior wall surface area is modified by inducing a low-pressure environment to allow plasma ions to travel a length of the elongated collection body, and
wherein the interior wall surface area of the elongated collection body is treated with an anticoagulant to enhance capillary action.

2. The blood collection device of claim 1, wherein the induced low-pressure is approximately 0.1 mbar or less.

3. The blood collection device of claim 1, wherein the anticoagulant is ammonium heparin.

4. The blood collection device of claim 1, wherein at least one of the first open end or the second open end includes a flared portion that is configured to receive a plug.

5. The blood collection device of claim 1, wherein the elongated collection body is approximately 75 mm in length.

6. The blood collection device of claim 1, wherein the plastic hematocrit tube is made from polycarbonate.

7. A blood collection assembly, comprising:
a plastic hematocrit tube having a first open end, a second open end opposite the first open end, and a sidewall which together define an elongated collection body,
wherein an interior wall surface area of the elongated collection body is treated with a plasma generated from a gas containing oxygen, whereby the plasma-treated interior wall surface area is modified by inducing a low-pressure to allow plasma ions to travel a length of the elongated collection body, and
wherein the interior wall surface area of the elongated collection body is treated with an anticoagulant to enhance capillary action; and
a plug configured to be inserted in one of the first end open end or the second open end.

8. The blood collection assembly of claim 7, wherein the applied low-pressure is approximately 0.1 mbar or less.

9. The blood collection assembly of claim 7, wherein the anticoagulant is ammonium heparin.

10. The blood collection assembly of claim 7, wherein at least one of the first open end or the second open end includes a flared portion that is configured to receive the plug.

11. The blood collection device of claim 7, wherein the elongated collection body is approximately 75 mm in length.

12. The blood collection assembly of claim 7, wherein the plastic hematocrit tube is made from polycarbonate.

13. The blood collection assembly of claim 7, wherein the plug is a clay based self-sealant plug.

14. The blood collection assembly of claim 13, wherein the plug includes at least one channel defining a passageway for extracting vapor contained in the tube.

15. A method for modifying an interior surface of a blood collection device, comprising:
placing a plastic hematocrit tube within a plasma discharge apparatus;
subjecting the plastic hematocrit tube with a plasma generated from a gas containing oxygen;
providing a low-pressure environment within the plasma discharge apparatus, whereby the low-pressure environment allows plasma ions to travel a length of an inner surface of the plastic hematocrit tube to form a modified inner surface thereof; and
treating the modified inner surface with an anticoagulant for enhanced capillary action.

16. The method of claim 15, wherein the low-pressure is applied at approximately 0.1 mbar or less.

17. The method of claim 15, wherein subjecting oxygen to the plastic hematocrit tube for approximately 5 min.

18. The method of claim 15, wherein treating the modified inner surface with an anticoagulant.

19. The method of claim 15, wherein treating the modified inner surface with a coating for enhanced capillary action.
